(19) United States
(12) Patent Application Publication
(10) Pub. No.: US 2016/0303445 A1
(43) Pub. Date: Oct. 20, 2016

(54) HOCKEY STICK HAVING REINFORCED CORE STRUCTURE

(71) Applicant: True Temper Sports, Inc., Memphis, TN (US)

(72) Inventors: Brian Christopher MOLLNER, SAN DIEGO, CA (US); Jonathan James ERREDGE, LA MESA, CA (US)

(21) Appl. No.: 15/099,041

(22) Filed: Apr. 14, 2016

Related U.S. Application Data
(60) Provisional application No. 62/147,909, filed on Apr. 15, 2015.

(51) Int. Cl. A63B 59/70; B29C 44/18

(52) U.S. Cl. CPC A63B 59/70; B29C 44/18; B29K 2063/00

(57) ABSTRACT

A blade for a hockey stick is provided. The blade includes a first core member and a covering member. The first core member includes a tube and an expanding foam core material disposed within the tube. The tube includes an upper wall, a lower wall, a front wall, and a rear wall and is preferably made from a resin impregnated carbon fiber material (i.e., pre-preg). The covering member is similarly made from a pre-preg material and includes a front inner surface and a rear inner surface. The covering member substantially surrounds the first core member. The pre-preg material is cured in a mold that causes the front and rear walls of the tube to bond to the front and rear inner surfaces of the covering member. The foam core material expands during the curing process to maintain the integrity of the wall structure of the tube.

### CROSS-REFERENCE TO RELATED APPLICATIONS

This application claims the benefit of U.S. Provisional Application No. 62/147,909, filed Apr. 15, 2015. The entire disclosure of the above application is incorporated herein by reference.

### FIELD

The present disclosure relates to a hockey stick, and more particularly to a hockey stick blade having a reinforced core structure.

### BACKGROUND

This section provides background information related to the present disclosure and is not necessarily prior art.

Hockey sticks include a blade that is often manufactured from a pre-impregnated material that includes a resin (e.g., epoxy) impregnated with fibers (e.g., carbon fibers). The pre-impregnated material can be wrapped or otherwise molded around a core structure and cured to form the blade such that the pre-impregnated material forms a skin or outer layer of the blade. Wrapping the pre-impregnated material around the core structure can compress the core structure and thereby cause the core structure to apply an outwardly extending pressure on an inner surface of the pre-impregnated material. In some cases, the core structure can include an air bladder that helps to produce the outwardly extending pressure on the pre-impregnated material. To stiffen the blade and strengthen the core structure during compression thereof, layers or ribs can extend across the core structure and join the inner surfaces of the pre-impregnated material. In this regard, the ribs can also be formed from the pre-impregnated material.

Various hockey sticks have been developed to address the stiffness and strength of the blade. For example, a further discussion of a hockey stick 10 having a blade 16 with core members 32, 34, 38 and a rib 42, including various configurations and functions thereof, may be found in commonly owned U.S. Pat. No. 8,628,437, which issued Jan. 14, 2014 to Mollner et al., and which is incorporated by reference herein in its entirety.

While known hockey sticks and blades have generally proven to be acceptable for their intended purpose, a continuous need for improvement in the relevant art remains. Specifically, it may be desirable to provide a hockey stick and blade having improved strength and stiffness.

### SUMMARY

This section provides a general summary of the disclosure, and is not a comprehensive disclosure of its full scope or all of its features.

In one aspect, the present disclosure provides a blade for a hockey stick. The blade may include a first core member and a covering member. The first core member may include a tube and a core material disposed within the tube. The tube may include an upper wall, a lower wall, a front wall, and a rear wall. The covering member may include a front inner surface and a rear inner surface. The covering member may substantially surround the first core member such that the front wall is adjacent the front inner surface, the rear wall is adjacent the rear inner surface, and the upper and lower walls extend transverse to the front and rear surfaces.

In some configurations, the tube member includes a material having braided fibers.

In some configurations, the braided fibers are selected from a group consisting of carbon fibers, glass fibers, and aramid fibers.

In some configurations, the core material includes a foam material.

In some configurations, the foam material includes an expanding foam material.

In some configurations, at least one of the upper and lower walls extends in a direction perpendicular to at least one of the front and rear inner surfaces.

In some configurations, the upper and lower walls extend in a direction perpendicular to at least one of the front and rear inner surfaces.

In some configurations, the core material applies a first force on the upper wall and a second force on the lower wall, and wherein the first force is perpendicular to the upper wall, and the second force is perpendicular to the lower wall.

In some configurations, the covering member is bonded to the tube.

In some configurations, the blade includes a second core member and a third core member. The first core member may be disposed between the second and third core members.

In another aspect, the present disclosure provides a blade for a hockey stick. The blade may include a first core member and a covering member. The first core member may include a braided fiber tube and a core material disposed within the braided fiber tube. The core material may be configured to apply an outwardly extending force on the braided fiber tube. The covering member may include a front inner surface and a rear inner surface. The covering member may substantially surround the first core member such that the braided fiber tube extends in at least first and second directions relative to the front and rear inner surfaces. The first direction may be parallel to the front and rear inner surfaces. The second direction may be perpendicular to the front and rear inner surfaces.

In some configurations, the outwardly extending force is perpendicular to the second direction.

In yet another aspect, the present disclosure provides a method of manufacturing a blade for a hockey stick. The method may include positioning a core material within a braided fiber tube. The braided fiber tube may include an upper wall, a lower wall, a front wall, and a rear wall. The method may also include positioning a first core member along the upper wall and positioning a second core member along the lower wall. The method may further include covering the braided fiber tube, the first core member, and the second core member with a covering member having a front inner surface and a rear inner surface. The method may also include curing the covering member such that the front wall is bonded to the front inner surface and the rear wall is bonded to the rear inner surface.

In some configurations, the method includes internally pressurizing the core material.

In some configurations, the method includes outwardly expanding the core material.

In some configurations, the core material applies an outward force on each of the upper and lower walls.

In some configurations, the outward force extends in a direction perpendicular to at least one of the upper and lower walls.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a front view of a hockey stick according to the principles of the present disclosure.

FIG. 2 is a cross-sectional view of a blade of the hockey stick of FIG. 1 taken along the line 2-2, according to the principles of the present disclosure.

FIG. 3 is an exploded view of the blade of the hockey stick of FIG. 1.

Corresponding reference numerals indicate corresponding parts throughout the several views of the drawings.

### DETAILED DESCRIPTION

Example embodiments will now be described more fully with reference to the accompanying drawings.

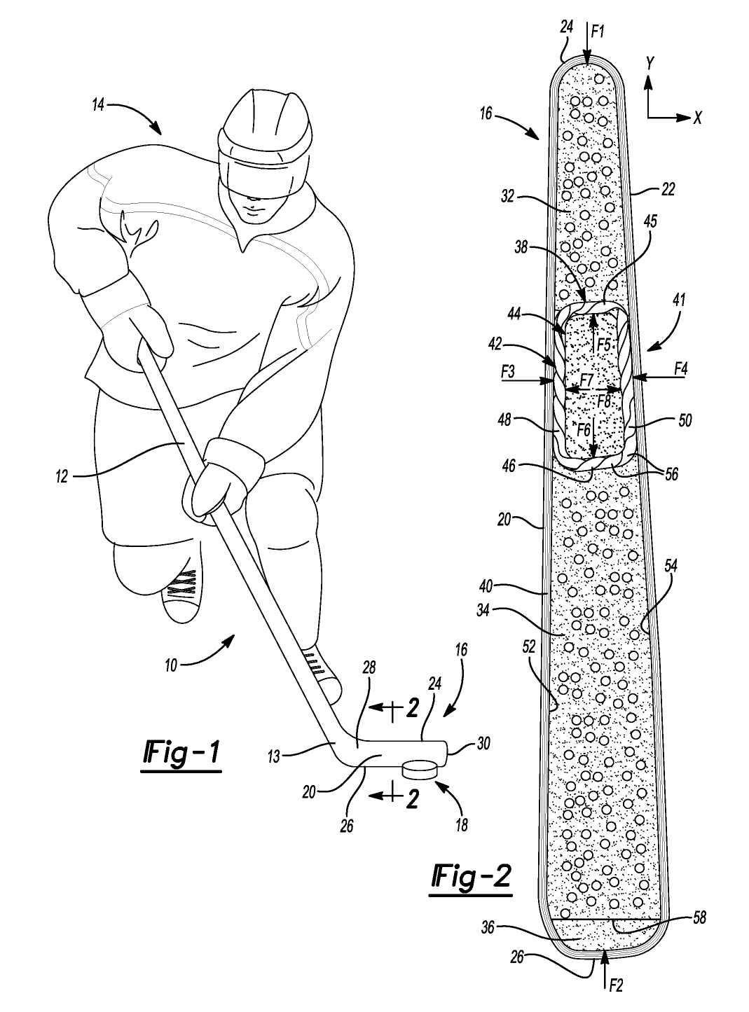

With reference to FIG. 1, an ice hockey stick 10 is illustrated. The hockey stick 10 generally includes a handle portion 12, which a player 14 holds, and a blade portion 16 (i.e., blade), which is used for controlling a puck 18. It will be appreciated that the hockey stick 10 can be adapted for any type of position on a hockey team, including that of a goalie, without departing from the scope of the present disclosure. It will also be appreciated that the teachings of the present disclosure can be applied to other related types of sports equipment, such as a field hockey stick, for example.

The handle portion 12 can include a blade connecting end 13. The blade portion 16 can be fixed to the blade connecting end 13 of the handle portion 12 in any suitable manner. It will be appreciated that the handle portion 12 and the blade portion 16 can be manufactured separately and subsequently attached together in a separate manufacturing process.

The blade portion 16 can generally include a front face 20 (FIGS. 1 and 2), which is most often used for receiving, passing and shooting the puck 18, and a rear face 22 (FIG. 2), which can also be used for receiving, passing and shooting the puck 18. Moreover, the blade portion 16 can include a first end 28 that is connected to the end 13 of the handle portion 12. The blade portion 16 can also include a second distal end 30 that is opposite to the first end 28. The blade portion 16 can additionally include a upper edge 24 that is typically spaced away from the playing surface (e.g., ice) and a lower edge 26 that often moves closely adjacent the playing surface. Both the upper and lower edges 24, 26 can extend between the first and second ends 28, 30 of the blade portion 16. Also, the upper and lower edges 24, 26 can have a slight curvature between the first and second ends 28, 30 such that the front face 20 is concave while the rear face 22 is convex.

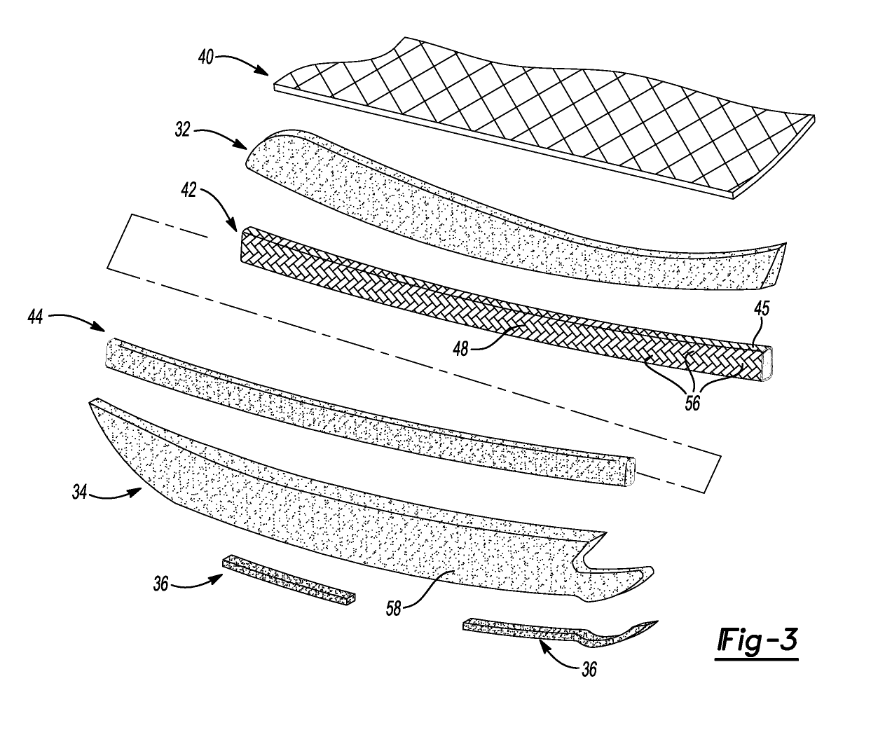

As shown in FIGS. 2 and 3, the blade portion 16 can include one or more core members 32, 34, 36, 38 that are covered and at least partially encased by a shell or covering member 40. The construction and manufacture of the handle portion 12 and/or blade portion 16, the attachment of the blade portion 16 to the handle portion 12, and other features of the hockey stick 10 can be according to the teachings of U.S. Pat. No. 6,893,596, issued May 17, 2005 to Haas et al. and/or U.S. Pat. No. 7,520,829, issued Apr. 21, 2009 to Mollner et al. Each of these patents is incorporated herein by reference in its entirety. The construction and manufacture of the core members 32, 34 and the covering member 40 can be according to the teachings of U.S. Pat. No. 8,628,437, which issued Jan. 14, 2014 to Mollner et al., and which is incorporated by reference herein in its entirety. In this regard, the core members 32, 34 may correspond to the core members 34, 36, respectively, of U.S. Pat. No. 8,628,437, and the covering member 40 may correspond to the covering member 38 of U.S. Pat. No. 8,628,437.

The core member 36 may include a structural, closed-cell foam material. As illustrated in FIG. 3, in some configurations the blade portion 16 includes a pair of core members 36 disposed proximate the lower edge 26 of the blade portion 16. A first of the core members 36 may be disposed proximate the first end 28 of the blade portion 16, and a second of the core members 36 may be disposed proximate the second end 30 of the blade portion 16.

The core member 38 will now be described with reference to FIGS. 2 and 3. In the preferred embodiment illustrated herein, the hockey stick 10 includes a single core member 38 disposed in a central region 41 of the blade portion 16 and extends substantially the entire length of the blade portion 20 from the first end 28 to the second end 30. In this regard, the core member 38 may be located between the core members 32, 34 relative to the upper and lower edges 24, 26 of the blade portion 16.

Also, the core members 32, 34, 38 can be included in any area of the hockey stick 10. In other configurations, the hockey stick 10 may include multiple core members 38, and/or multiple core members 32, 34, disposed between the upper and lower edges 24, 26 of the blade portion 16. In other words, multiple internal core members 38 may be used throughout the core structure to improve the durability of the blade portion 16 or change its performance characteristics.

As shown, the core member 38 may include a tube 42 and a core material 44 disposed within the tube 42. In particular, the tube 42 may surround or encapsulate the core material 44 such that the core material 44 is isolated from each of the core members 32, 34 and the covering member 40. Accordingly, the tube 42 may be disposed between the core material 44 and the core members 32, 34 and/or the covering member 40. For example, the tube 42 may have a substantially rectangular-shaped cross-section including an upper wall 45, a lower wall 46, a front wall 48, and a rear wall 50. The front and rear walls 48, 50 may extend from and between the upper and lower walls 45, 46 such that the tube 42 defines a solid or continuous perimeter. In an assembled configuration, the upper and/or lower walls 45, 46 may extend from and between a front inner surface 52 and a rear inner surface 54 of the covering member 40, while the front and rear walls 48, 50 may extend along or adjacent to the front and rear inner surfaces 52, 54 of the covering member 40. Specifically, in some configurations the upper and/or lower walls 45, 46 extend horizontally, or otherwise in a direction substantially perpendicular (+/−15 degrees) to the front and/or rear inner surfaces 52, 54 of the covering member 40, while the front and/or rear walls 48, 50 extend vertically, or otherwise in a direction substantially parallel (+/−15 degrees) to the front and rear inner surfaces 52, 54. Thus, the upper and lower walls 45, 46 of the core member 38 effectively serve as transverse ribs joining and supporting the front and rear faces 20 and 22 of the blade portion 16.

At least a portion of the tube 42 can be made out of a lightweight, high-strength composite material. For instance, at least a portion of the tube 42 can include a plurality of fibers 56, such as carbon fibers, that are woven or braided into a mesh. It will be appreciated that while the fibers 56 are described as being carbon fibers, the fibers 56 may comprise other types of fibers, including other types of braided fibers, within the scope of the present disclosure. For example, the fibers 56 can also comprise glass, aramid, and/or other suitable types of fibers. The braided fiber tube 42 can be injected with a resin material that causes the walls 48 and 50 of the tube 42 to adhere to the inner surfaces 52 and 54 of the covering member 40 during the curing process explained below.

The core material 44 can include an expanding foam material. In some configurations the core material 44 includes an expanding foam adhesive material. For example, in some configurations a particularly suitable core material 44 is a foaming adhesive film material such as REDUX 206™, commercially available from Hexcel Composites Corporation, AX-2190™, a foaming epoxy core adhesive material commercially available from Axiom Materials, Inc., or NB51-301™, a foaming composite film adhesive material commercially available from Mitsubishi Rayon Carbon Fiber and Composites, Inc. As will be explained in more detail below, in an assembled configuration the expanding nature of the core material 44 can apply a radially outward force on the tube 42.

A method of manufacturing the hockey stick 10, including the blade portion 16, will now be described with reference to at least FIG. 3. The method may include providing the tube 42 and placing the core material 44 within the tube 42, or otherwise encapsulating the core material 44 with the tube 42, to form the core member 38. The core member 38 can be positioned between the core members 32, 34 such that the upper and lower walls 45, 46 engage the core members 32, 34, respectively. The core members 36 can be placed along a lower edge 58 of the core member 34. Carbon fiber laminates pre-impregnated with resin—i.e., pre-preg material—can be wrapped around and laid over the subassembly of core members 32, 34, 36, 38 to form the covering member 40.

The covering member 40 and the subassembly of core members 32, 34, 36, 38 undergo a curing process in an external mold (not shown). The curing process causes a pressure to be applied to the covering member 40 when the mold is closed, compressing the covering member 40 around, and thereby bonding it to the core members 32, 34, 36, 38. Accordingly, the curing process causes the covering member 40 to apply inwardly extending forces on the core members 32, 34, 36, 38. For example, the curing process causes the covering member 40 to apply inward forces F1, F2 along the Y-axis and inward forces F3, F4 along the X-axis. During the curing process, the core material 44 can be pressurized internally such that the core material 44 applies outwardly extending forces on the tube 42, opposite the inwardly extending forces applied by the covering member 40. This internal pressure can be produced by the expanding foam core material 44 as it cures within tube 42. In addition, the pre-preg outer skin material 40 and the braided inner core member 38 are cured together, thereby bonding the walls 48 and 50 of the tube 42 to the inner surfaces 52 and 54 of the covering member 40.

For example, in some configurations the curing process causes the core material 44 to expand outwardly to apply force F5, F6 on the tube 42 along the Y-axis and force F7, F8 on the tube 42 along the X-axis. In this regard, the forces F5, F6 may extend in a direction generally perpendicular to the upper and lower walls 45, 46 of the tube 42, and the forces F7, F8 may extend in a direction generally perpendicular to the front and rear walls 48, 50 of the tube 42. In other configurations, the core material 44 may be internally pressurized with air in order to apply the forces F5, F6 and/or F7, F8. The forces F5, F6 and F7, F8 can offset the forces F1, F2 and F7, F8, respectively, to prevent the upper and/or lower walls 45, 46 of the tube 42 from buckling or otherwise deforming during and/or after the curing process. In this regard, the upper and/or lower walls 45, 46 may be generally parallel to one another and generally perpendicular to the front and rear inner surfaces 52, 54 of the covering member 40 both before and after the curing process.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A hockey stick having a handle portion and a blade portion connected to the handle portion, the blade portion comprising:
a first core member including a tubular member extending lengthwise along said blade portion, said tubular member having a substantially rectangular-shaped cross-section defining an upper wall, a lower wall, a front wall and a rear wall, and a core material disposed within said tubular member; and
a covering material surrounding said first core member and having a front face and a front inner surface and a rear face and a rear inner surface, and upper and lower edges joining said front and rear surfaces such that said covering material defines a hollow interior between said front and rear inner surfaces;
wherein said first core member is disposed in said hollow interior such that said front wall of said tubular member is bonded to said front inner surface of said covering material and said rear wall of said tubular member is bonded to said rear inner surface of said covering material; and further
wherein said upper and lower walls of said tubular member extend transversely between said front and rear inner surfaces of said covering material.

2. The hockey stick of claim 1, wherein said first core member is disposed centrally within said hollow interior so as to define a first space between the upper wall of said tubular member and the upper edge of said cover material, and a second space between the lower wall of said tubular member and the lower edge of said cover material.

3. The hockey stick of claim 1, further including a second core member disposed in said hollow interior so as to substantially fill said first space.

4. The hockey stick of claim 3, further including a third core member disposed within said hollow interior so as to substantially fill said second space.

5. The hockey stick of claim 1, wherein the tube member includes a material having braided fibers.

6. The hockey stick of claim 5, wherein the braided fibers are selected from a group consisting of carbon fibers, glass fibers, and aramid fibers.

7. The hockey stick of claim 1, wherein the core material includes a foam material.

8. The hockey stick of claim 7, wherein the foam material includes an expanding foam material.

9. The hockey stick of claim 1, wherein said tubular member and said covering material are formed from material comprising resin impregnated with fibers, and further wherein said tubular member is bonded to said front and rear inner surfaces of said covering material when said resin is cured.

10. The hockey stick of claim 9, wherein said core material comprises a foam material that expands when said resin is being cured.

11. The hockey stick of claim 10, wherein said core material when expanding applies a first force on the upper wall and a second force on the lower wall.

12. The hockey stick of claim 10, wherein said core material when expanding applies a third force on the front wall and a fourth force on the rear wall.

13. A method of manufacturing a blade for a hockey stick, the method comprising:
providing an elongated first core member comprising a resin impregnated outer fiber tube, the fiber tube having an upper wall, a lower wall, a front wall, and a rear wall;
depositing within said fiber tube an inner foam core material;
positioning a second core member along the upper wall;
positioning a third core member along the lower wall;
covering the fiber tube of the first core member, the second core member and the third core member with a covering member having a front inner surface and a rear inner surface, said covering member comprising a resin impregnated fiber material; and
curing the covering member and the fiber tube such that the front wall of the fiber tube is bonded to the front inner surface of the covering member and the rear wall of the fiber tube is bonded to the rear inner surface of the covering member.

14. The method of claim 13, further comprising the step of internally pressurizing the core material.

15. The method of claim 13, wherein said foam core material comprises an expanding foam material that applies an outwardly directed force on the walls of said fiber tube during said curing step.
